(19) United States
(12) Patent Application Publication
(10) Pub. No.: US 2026/0039573 A1
(43) Pub. Date: Feb. 5, 2026

(54) ENHANCED COMMUNICATION NETWORK AUTOMATED TESTING

(71) Applicant: Level 3 Communications, LLC, Denver, CO (US)

(72) Inventors: William FEIGHT, Bennett, CO (US); Mary HUGHSON, Rochester, NY (US); Jason ROGERS, Parker, CO (US)

(73) Assignee: Level 3 Communications, LLC, Denver, CO (US)

(21) Appl. No.: 19/277,984

(22) Filed: Jul. 23, 2025

Related U.S. Application Data
(60) Provisional application No. 63/678,238, filed on Aug. 1, 2024.

(51) Int. Cl. H04L 43/065; H04B 10/075; H04L 43/045; H04L 43/50

(52) U.S. Cl. CPC H04L 43/065; H04B 10/075; H04L 43/045; H04L 43/50

(57) ABSTRACT

This disclosure describes systems, methods, and devices related to remotely testing communication network equipment. A system may include a communications network including network equipment configured to facilitate communications in the communications network; fiber connections physically connecting test equipment to a network element of the network equipment; and automated testing software remote from the network element and from the test equipment, able to: turn up the test equipment via one or more interfaces; turn up the network element via the one or more interfaces; and send, via the one or more interfaces, wireless command signals to the test equipment to perform testing of the network element via the fiber connections.

### CROSS-REFERENCE TO RELATED APPLICATIONS

This application claims priority to U.S. Provisional Patent Application No. 63/678,238, filed Aug. 1, 2024, the entire contents of which are incorporated herein by reference in their entirety.

### TECHNICAL FIELD

The disclosed technology generally relates to devices, systems, and methods for automated testing for communication networks.

### BACKGROUND

Communications networks include many network devices for controlling transportation and routing of data. Testing of communication network devices may verify whether the devices are operating correctly, simulating traffic, and performing properly under various conditions.

### SUMMARY

According to some embodiments, a system for remotely testing communication network equipment is disclosed, which can include a communications network comprising network equipment configured to facilitate communications in the communications network; fiber connections physically connecting test equipment to a network element of the network equipment; and automated testing software remote from the network element and from the test equipment, and able to: turn up the test equipment via one or more interfaces; turn up the network element via the one or more interfaces; and send, via the one or more interfaces, wireless and wired command signals to the test equipment to perform testing of the network element via the fiber connections.

According to some embodiments, a non-transitory computer-readable medium is disclosed, which can include instructions associated with remotely testing communications network equipment, wherein when the instructions are executed by at least one processor, cause the at least one processor to: access, using automated testing software of a device and via an application programming interface, test equipment physically remote from the device and physically connected to a network element of communications network equipment; turn up, using the automated testing software, the test equipment via the application programming interface; turn up, using the automated testing software, the network element via the application programming interface; and perform, using the automated testing software, remote testing of the network element by sending commands to the test equipment via the application programming interface.

According to some embodiments, a method for remotely testing communications network equipment is disclosed, which can include accessing, by automated testing software of a device and via an application programming interface, test equipment physically remote from the device and physically connected to a network element of communications network equipment; turning up, by the automated testing software, the test equipment via the application programming interface; turning up, by the automated testing software, the network element via the application programming interface; and performing, by the automated testing software, remote testing of the network element by sending commands to the test equipment via the application programming interface.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates an example flow for remote automated testing of communication network elements in accordance with one embodiment.

FIG. 2 illustrates an example flow for laboratory data integrations to facilitate the remote automated testing of FIG. 1 in accordance with one embodiment.

FIG. 3 illustrates and example flow for the remote automated testing of FIG. 1 in accordance with one embodiment with an exemplary system for event-driven service health assessment using persistent paths in accordance with one embodiment.

FIG. 4 is a flowchart illustrating a process for remote automated testing of communication network elements in accordance with one embodiment.

FIG. 5 is a diagram illustrating an example of a computing system that may be used in implementing embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4th or 5th generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, aspects of the present disclosure involve devices, systems, methods, and the like, for an enhanced communications network automated testing.

Communications networks may include many network elements in communication with a network, including physical devices such as routers, switches, optical transport devices, servers, hubs, and the like. Communication network providers may test network elements to verify whether the network elements are operating correctly, simulating traffic, and performing properly under various conditions.

In test environments with physical networking hardware, particularly in telecommunications networks, manual fiber connections may physically connect optical fibers to network devices or test equipment. Physical test equipment for testing the network elements may include physical devices for testing network parameters and conditions, and may include signal generators, performance analyzers, and other diagnostic tools that verify the operation of network components under controlled test scenarios such as throughput, optical switch times, and error tests such as loss of signal (LOS) and loss of frame (LOF).

Current physical testing of network elements for communications networks requires a human operator to physically be present with the testing equipment to manually control tests monitor and interpret data provided by the testing equipment.

To control testing of communication network element testing remotely, the testing may be automated. However, there is currently no remote testing technique that facilitates remote network element testing by remotely turning up network elements with software and controlling the testing equipment remotely with software. In addition, network elements may lack graphical user interfaces with which to monitor their behaviors in response to commands used to test the network elements.

In one or more embodiments, the enhanced remote testing of communication network elements may include automated testing software, which may enable the creation, scheduling, and execution of test plans and cases. The software may drive the testing process by interfacing with various systems and network elements to validate their performance and behavior. The automated testing software may include features for test management, reporting, and integration with other tools to streamline a testing lifecycle.

In one or more embodiments, the enhanced remote testing of communication network elements may include network element management systems (EMS), which are dedicated applications or platforms that manage network elements such as switches, routers, electrical equipment, and other networking hardware. The EMS may facilitate configuration monitoring, provisioning, and maintenance tasks. In the automated testing herein, the EMS may provide information about network state or may be a target for testing to ensure that management operations are functioning correctly.

In one or more embodiments, the enhanced remote testing of communication network elements may include the network elements being tested. The network elements may refer to any individual component that participates in communications within a network, and may be physical devices, such as a router, switch, or optical transport device, for example. Automated tests may interact with network elements to verify that the network elements are operating correctly, simulating traffic, and measuring performance under various conditions.

In one or more embodiments, the enhanced remote testing of communication network elements may include command line interfaces (CLIs) used for interaction with software or network elements. CLIs allow for the configuration, administration, and retrieval of information through commands entered via a console. The automated tests herein may use CLI, Transaction Language 1 (TL1), simple network management protocol (SNMP), or the like, to execute a sequence of commands on network elements, and observe the responses to the commands, which may be essential for validating behaviors that lack a graphical user interface.

In one or more embodiments, the enhanced remote testing of communication network elements may include application programming interfaces (APIs) to enable software components to communicate with each other. The APIs may define a set of rules and protocols for building and interacting with software applications. In the automated testing herein, APIs may be used to programmatically control test processes, integrate with other applications or network elements, and validate the functionality and reliability of the APIs themselves.

In one or more embodiments, the enhanced remote testing of communication network elements may include graphical user interfaces (GUIs) for providing a visual way for users to interact with network elements. GUIs may be tested to ensure that visual and interactive elements of an application function as intended. Testing may include verifying correctness of information, responsiveness of buttons and menus, input fields, and overall usability. For resource-facing services, GUIs may be used as a fallout when back-end automation fails.

In one or more embodiments, the enhanced remote testing of communication network elements may include manual fiber connections. In test environments with physical hardware, such as is telecommunications, manual fiber connections refer to the physical process of connecting optical fibers to devices or test equipment. Ports may be daisy chained with fiber jumpers and connected into test sets to test performance parameters.

In one or more embodiments, the enhanced remote testing of communication network elements may include test set physical testing devices. The test sets may be specialized physical devices used to test various network parameters and conditions of the network elements, and may include signal generators, performance analyzers, and other diagnostic tools that verify operation of network components under controlled test scenarios, such as throughput, optical switch times, and error tests such as LOS and LOF.

In one or more embodiments, the enhanced remote testing of communication network elements may include data integrations. These interfaces may act as a bridge between an automated test suite and external tools (e.g., software for bug and issue tracking, etc.). The data integrations may streamline testing by allowing easy transfer of test cases, requirements, and results between different systems. The integrations ensure that the testing workflow is well-aligned with project management and documentation efforts, improving the efficiency of collaboration.

In one or more embodiments, the hardware and software organization used for the enhanced remote testing of communication network elements may use a document submission portal as a digital repository that facilitates organized submissions and management of documents. The document submission portal may use a secure access (e.g., authentication keys or the like), an ability to track document versions, streamlined categorization, and robust search capabilities. A project management and issue tracker may represent a comprehensive tool for tracking the progress of projects, managing tasks, and logging issues or bugs. The system may centralize product information, establish a transparent workflow, set milestones, and provide project insights and status.

In one or more embodiments, the automated testing software may enable creation, scheduling, and execution of test plans and cases, and may interface with system and network components to validate their performance and behavior. The project management and issue tracker may track progress of tasks and projects that include automated testing of network components with the automated testing software. The automated testing software may include features for test management, reporting, and integration with other tools to streamline the testing lifecycle.

In one or more embodiments, a communication channel may represent an interactive platform designed to facilitate collaboration and communication. This software may support instant messaging, voice and video calls, file sharing, and integration with other productivity tools. The communications channel may serve as a virtual space for teams to connect, share ideas, discuss projects, and the like.

The above descriptions are for purposes of illustration and are not meant to be limiting. Numerous other examples, configurations, processes, etc., may exist, some of which are described in greater detail below. Example embodiments will now be described with reference to the accompanying figures.

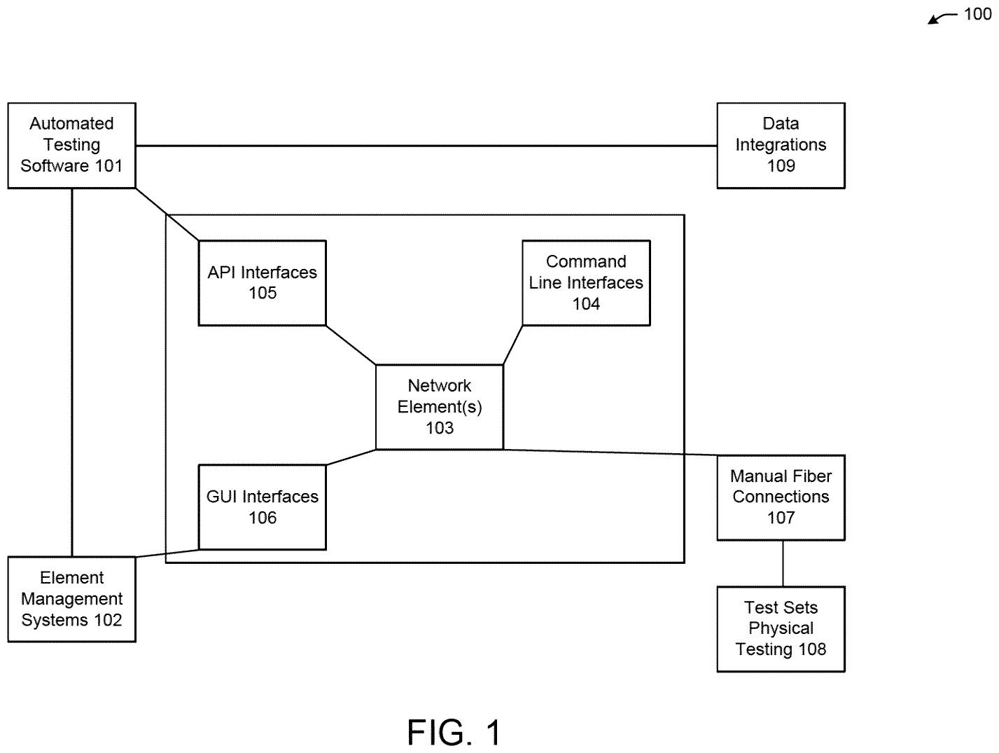

FIG. 1 illustrates an example flow 100 for remote automated testing of communication network elements in accordance with one embodiment.

Referring to FIG. 1, automated testing software 101 may integrate with element management systems 102 for the remote automated testing of communication network elements 103. The remote automated testing may use command line interfaces 104, API interfaces 105, and GUI interfaces 106. The remote testing of the network elements 103 may be facilitated by manual fiber connections 107. Test sets physical testing 108 may control the testing via the manual fiber connections 107 to the network elements 103, and the automated testing software 101 may remotely control the test sets physical testing 108.

In one or more embodiments, the enhanced remote testing of the communication network elements 103 may include the automated testing software 101, which may enable the creation, scheduling, and execution of test plans and cases. The automated testing software 101 may drive the testing process by interfacing with various systems and network elements 103 to validate their performance and behavior. The automated testing software 101 may include features for test management, reporting, and integration with other tools to streamline a testing lifecycle.

In one or more embodiments, the enhanced remote testing of communication network elements 103 may include the network element management systems 102 (EMS), which are dedicated applications or platforms that manage network elements 103 such as switches, routers, electrical equipment, and other networking hardware. The EMS 102 may facilitate configuration monitoring, provisioning, and maintenance tasks. In the automated testing herein, the EMS 102 may provide information about network state or may be a target for testing to ensure that management operations are functioning correctly.

In one or more embodiments, the enhanced remote testing of communication network elements 103 may include the network elements 103 being tested. The network elements 103 may refer to any individual component that participates in communications within a network, and may be physical devices, such as a router, switch, or optical transport device, for example. The network elements 103 may also be represented by a computer simulated device. The automated testing software 101 may interact with the network elements 103 to verify that the network elements 103 are operating correctly, simulating traffic, and measuring performance under various conditions.

In one or more embodiments, the enhanced remote testing of communication network elements 103 may include command line interfaces 104 (CLIs) used for interaction with the automated testing software 101 and/or network elements 103. CLIs 104 allow for the configuration, administration, and retrieval of information through commands entered via a console. The automated testing software 101 herein may use CLI, Transaction Language 1 (TL1), simple network management protocol (SNMP), or the like, to execute a sequence of commands on network elements 103, and observe the responses to the commands, which may be essential for validating behaviors that lack a graphical user interface.

In one or more embodiments, the enhanced remote testing of communication network elements 103 may include application programming interfaces (APIs) 105 to enable software components to communicate with each other. The APIs 105 may define a set of rules and protocols for building and interacting with software applications. In the automated testing herein, APIs 105 may be used to programmatically control test processes, integrate with other applications or network elements 103, and validate the functionality and reliability of the APIs 105 themselves.

In one or more embodiments, the enhanced remote testing of communication network elements 103 may include graphical user interfaces (GUIs) 106 for providing a visual way for users to interact with network elements 103. GUIs 106 may be tested to ensure that visual and interactive elements of an application function as intended. Testing may include verifying correctness of information, responsiveness of buttons and menus, input fields, and overall usability. For resource-facing services, GUIs 106 may be used as a fallout when back-end automation fails.

In one or more embodiments, the enhanced remote testing of communication network elements 103 may include manual fiber connections 107. In test environments with physical hardware, such as is telecommunications, manual fiber connections 107 refer to the physical process of connecting optical fibers to devices or test equipment. Ports may be daisy chained with fiber jumpers and connected into test sets to test performance parameters.

In one or more embodiments, the enhanced remote testing of communication network elements 103 may include test set physical testing devices 108. The test sets may be specialized physical devices used to test various network parameters and conditions of the network elements 103, and may include signal generators, performance analyzers, and other diagnostic tools that verify operation of network components under controlled test scenarios, such as throughput, optical switch times, and error tests such as LOS and LOF.

In one or more embodiments, the enhanced remote testing of communication network elements 103 may include data integrations 109. These interfaces may act as a bridge between an automated test suite and external tools (e.g., software for bug and issue tracking, etc.). The data integrations 109 may streamline testing by allowing easy transfer of test cases, requirements, and results between different systems. The integrations 109 ensure that the testing workflow is well-aligned with project management and documentation efforts, improving the efficiency of collaboration.

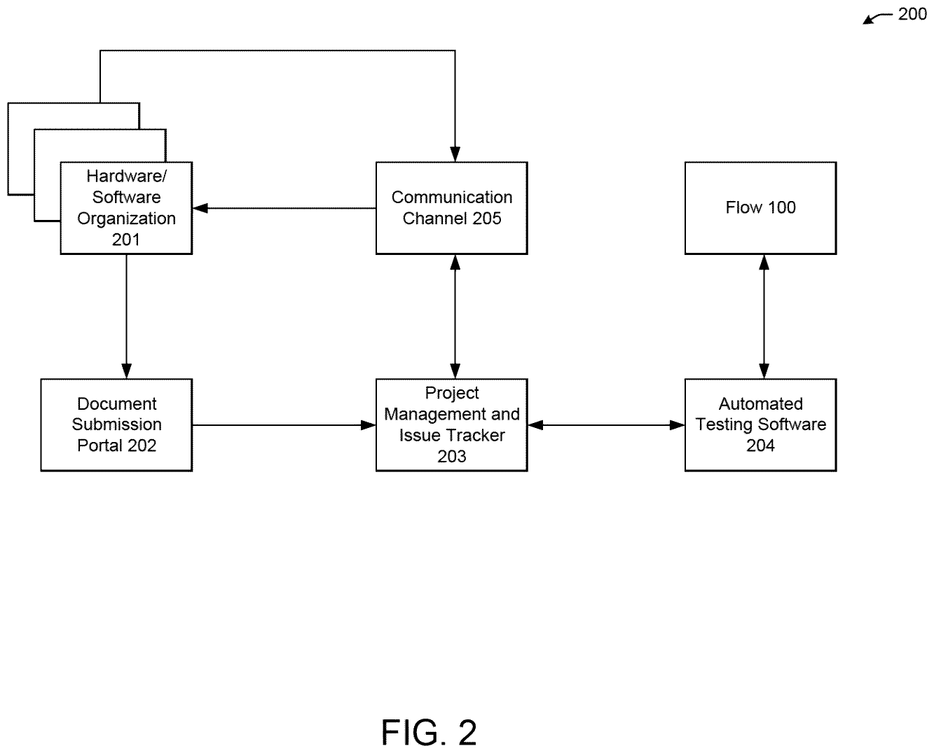

FIG. 2 illustrates an example flow 200 for laboratory data integrations to facilitate the remote automated testing of FIG. 1 in accordance with one embodiment.

Referring to FIG. 2, a hardware/software organization 201 may submit and access documents via a document submission portal 202. A project management and issue tracker 203 may manage projects based on documents from the document submission portal 202, and by using automated testing software 204 to perform automated remote testing according to the flow 100 of FIG. 1. The hardware/software organization 201 and the project management and issue tracker 203 may use a communication channel 205.

In one or more embodiments, the hardware and software organization 201 used for the enhanced remote testing of communication network elements 103 may use the document submission portal 202 as a digital repository that facilitates organized submissions and management of documents. The document submission portal 202 may use a secure access (e.g., authentication keys or the like), an ability to track document versions, streamlined categorization, and robust search capabilities. The project management and issue tracker 203 may represent a comprehensive tool for tracking the progress of projects, managing tasks, and logging issues or bugs. The system may centralize product information, establish a transparent workflow, set milestones, and provide project insights and status.

In one or more embodiments, the automated testing software may enable creation, scheduling, and execution of test plans and cases, and may interface with system and network components to validate their performance and behavior. The project management and issue tracker 203 may track progress of tasks and projects that include automated testing of network components with the automated testing software 204. The automated testing software 204 may include features for test management, reporting, and integration with other tools to streamline the testing lifecycle.

In one or more embodiments, the communication channel 205 may represent an interactive platform designed to facilitate collaboration and communication. This software may support instant messaging, voice and video calls, file sharing, and integration with other productivity tools. The communications channel 205 may serve as a virtual space for teams to connect, share ideas, discuss projects, and the like.

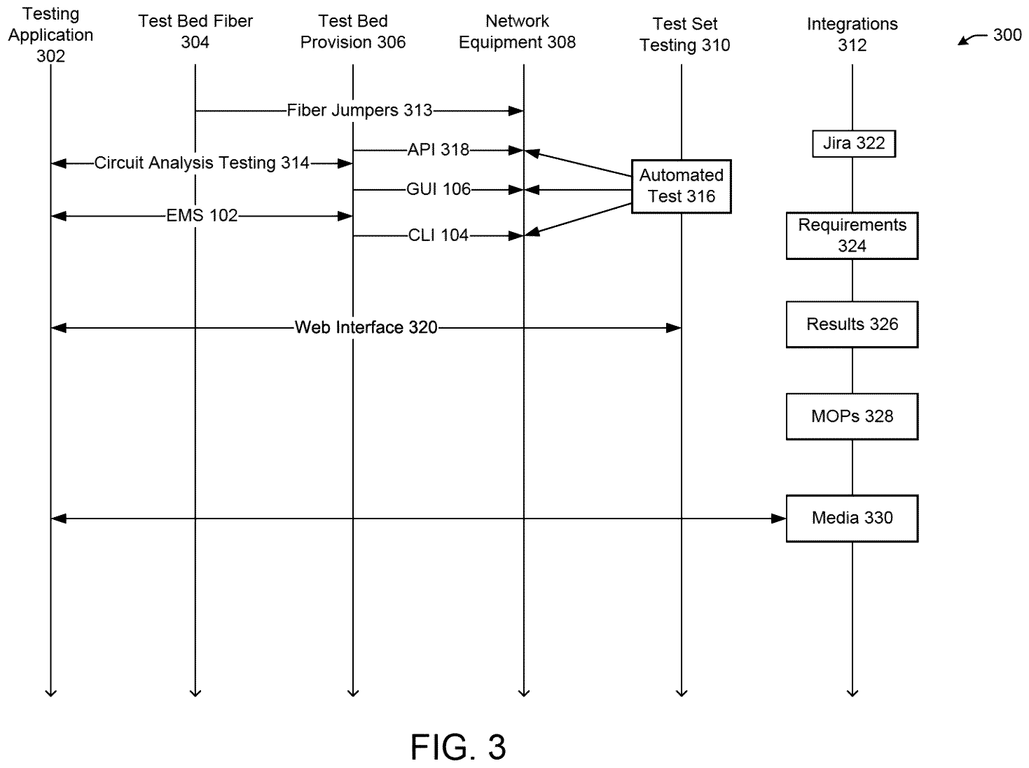

FIG. 3 illustrates and example flow 300 for the remote automated testing of FIG. 1 in accordance with one embodiment.

Referring to FIG. 3, the flow 300 may include a testing application 302 (e.g., the automated testing software 101), test bed fiber 304 (e.g., the manual fiber connections 107), a test bed provision 306, network equipment 308 (e.g., the network elements 103), test set testing (e.g., the test sets physical testing 108), and integrations 312 (e.g., the data integrations 109).

The test bed fiber 304 may connect fiber jumpers 313 to the network equipment 308 to establish physical connections with the network element being tested. The testing application 302 may access circuit analysis testing 314 and the EMS 102 of the test bed provision 314, which may use an API 318 (e.g., the API interfaces 105), a GUI 106, and a CLI 104 to access and communicate with the network equipment 308 for the testing. The test set testing 310 may perform an automated test 316 of the network equipment 308. The testing application 302 may access a test pool web interface 320 to control the automated test 316 remotely. The integrations 312 may include a Jira 322, test requirements 324 integration, test results 326 integration, MOPs 328 integration (e.g., maintenance operations protocols for the remote testing), and media 330 integrations so that the testing application 302 may control the automated test 316 remotely, monitor progress of the testing, and see the test results.

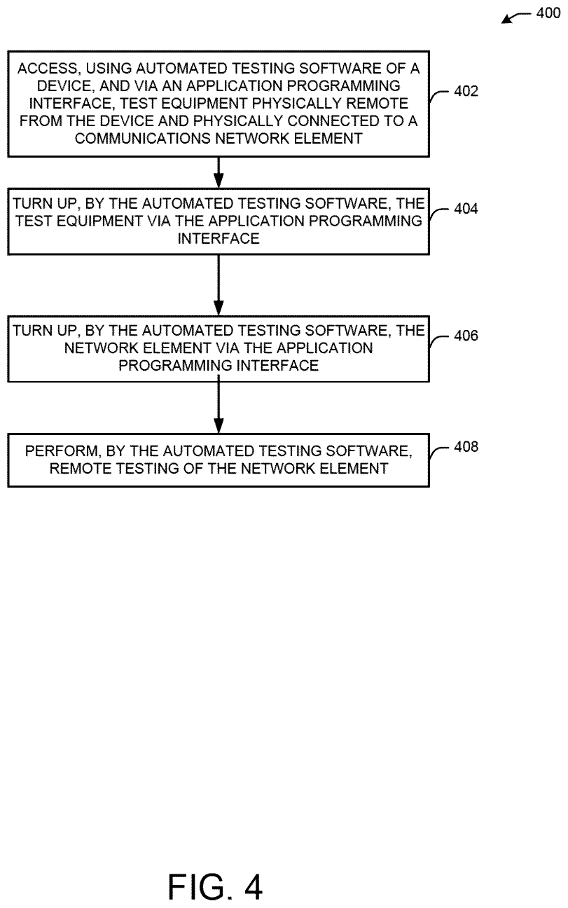

FIG. 4 is a flowchart illustrating a process 400 for remote automated testing of communication network elements in accordance with one embodiment. Such operations of process 400 are discussed above.

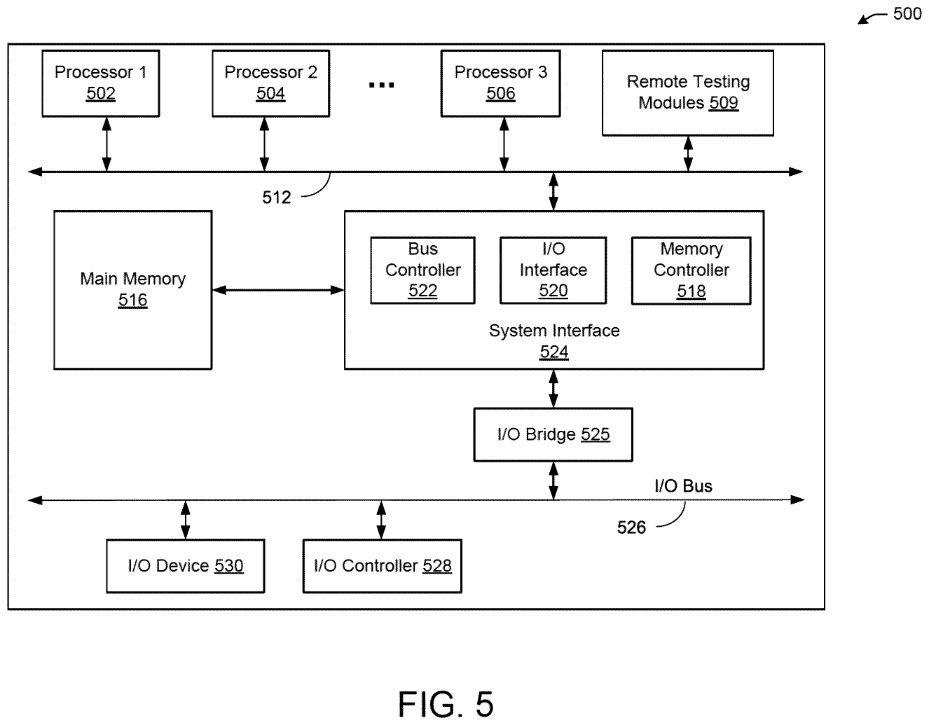

At block 402, a device (or system, e.g., the components of FIGS. 1 and 2, the remote testing modules 509 of FIG. 5) may access, using automated testing software of, via an API, test equipment physically remote from the device and physically connected to a communications network element.

At block 404, the device may turn up, using the automated testing software, the test equipment via the API.

At block 406, the device may turn up, using the automated testing software, the network element via the API.

At block 408, the device may use the automated testing software to perform remote testing of the network element via the test equipment.

It is understood that the above descriptions are for purposes of illustration and are not meant to be limiting.

FIG. 5 is a block diagram illustrating an example of a computing device or computer system 500 which may be used in implementing the embodiments of the components of the network disclosed above. For example, the computing system 500 of FIG. 5 may represent at least a portion of the components of FIG. 1, and discussed above. The computer system (system) includes one or more processors 502-506 and one or more remote testing modules 509 (e.g., representing at least a portion of the components of FIG. 1, and/or the components of FIG. 2, and/or the components of FIG. 3, capable of performing any operations described with respect to FIGS. 1-4). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A system comprising:
a communications network comprising network equipment configured to facilitate communications in the communications network;
fiber connections physically connecting test equipment to a network element of the network equipment; and
automated testing software remote from the network element and from the test equipment, and configured to:
turn up the test equipment via one or more interfaces;
turn up the network element via the one or more interfaces; and
send, via the one or more interfaces, wireless and/or wired command signals to the test equipment to perform testing of the network element via the fiber connections.

2. The system of claim 1, further comprising an element management system (EMS) configured to:
provide, to the automated testing software, via the one or more interfaces, information about a state of the network element during the testing.

3. The system of claim 1, further comprising data integration interfaces configured to facilitate communications between the automated testing software and external software associated with software bugs of the automated testing software.

4. The system of claim 1, further comprising a command line interface configured to:
receive, from the automated testing software, commands associated with the testing, wherein the wireless command signals are based on the commands; and
retrieve information associated with the testing.

5. The system of claim 1, further comprising an application programming interface configured to:
programmatically control test processes associated with the testing; and
communicate with the network element and the automated testing software.

6. The system of claim 1, further comprising a graphical user interface configured to:
visually interact with the network element and the automated testing software.

7. The system of claim 1, wherein the network equipment comprises routers, switches, optical transport devices, servers, and hubs.

8. A non-transitory computer-readable medium comprising instructions, that when executed by at least one processor, cause the at least one processor to:
access, using automated testing software of a device and via an application programming interface, test equipment physically remote from the device and physically connected to a network element of communications network equipment;
turn up, using the automated testing software, the test equipment via the application programming interface;
turn up, using the automated testing software, the network element via the application programming interface; and
perform, using the automated testing software, remote testing of the network element by sending commands to the test equipment via the application programming interface.

9. The non-transitory computer-readable medium of claim 8, wherein execution of the instructions further causes the at least one processor to:
provide, to the automated testing software, using an element management system, information about a state of the network element during the testing.

10. The non-transitory computer-readable medium of claim 8, wherein execution of the instructions further causes the at least one processor to:
facilitate, using data integration interfaces, communications between the automated testing software and external software associated with software bugs of the automated testing software.

11. The non-transitory computer-readable medium of claim 8, wherein execution of the instructions further causes the at least one processor to:
receive, by a command line interface, from the automated testing software, commands associated with the testing, wherein the command signals are based on the commands; and
retrieve, by the command line interface, information associated with the testing.

12. The non-transitory computer-readable medium of claim 8, wherein execution of the instructions further causes the at least one processor to:
programmatically control, using the application programming interface, test processes associated with the testing; and
communicate, using the application programming interface, with the network element and the automated testing software.

13. The non-transitory computer-readable medium of claim 8, wherein execution of the instructions further causes the at least one processor to:
visually interact, via a graphical user interface, with the network element and the automated testing software.

14. The non-transitory computer-readable medium of claim 8, wherein the network equipment comprises routers, switches, optical transport devices, servers, and hubs.

15. A method comprising:
accessing, by automated testing software of a device and via an application programming interface, test equipment physically remote from the device and physically connected to a network element of communications network equipment;
turning up, by the automated testing software, the test equipment via the application programming interface;
turning up, by the automated testing software, the network element via the application programming interface; and
performing, by the automated testing software, remote testing of the network element by sending commands to the test equipment via the application programming interface.

16. The method of claim 15, further comprising:
providing, to the automated testing software, using an element management system, information about a state of the network element during the testing.

17. The method of claim 15, further comprising:
facilitating, using data integration interfaces, communications between the automated testing software and external software associated with software bugs of the automated testing software.

18. The method of claim 15, further comprising:
receiving, by a command line interface, from the automated testing software, commands associated with the testing, wherein the command signals are based on the commands; and
retrieving, by the command line interface, information associated with the testing.

19. The method of claim 15, further comprising:
programmatically controlling, using the application programming interface, test processes associated with the testing; and
communicating, using the application programming interface, with the network element and the automated testing software.

20. The method of claim 15, further comprising:
visually interacting, via a graphical user interface, with the network element and the automated testing software.
